(19) United States
(12) Patent Application Publication
(10) Pub. No.: US 2006/0017443 A1
(43) Pub. Date: Jan. 26, 2006

(54) Deep reading propagation resistivity tool for determination of distance to a bed boundary with a transition zone

(75) Inventors: Martin Folberth, Lower Saxony (DE); Sheng Fang, Houston, TX (US); Tsili Wang, Katy, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/183,139

(22) Filed: Jul. 15, 2005

Related U.S. Application Data
(63) Continuation-in-part of application No. 10/897,715, filed on Jul. 23, 2004.
(60) Provisional application No. 60/640,899, filed on Dec. 30, 2004.

(51) Int. Cl. G01V 3/08

(52) U.S. Cl. 324/338

(57) ABSTRACT

A resistivity logging tool suitable for downhole use includes a transmitter, two spaced apart receivers. The measured signals are inverted to determine the distance to a boundary in the earth formation in the presence of a transition zone in resistivity. The direction of drilling may be controlled based on the determined distance.

### CROSS-REFERENCES TO RELATED APPLICATIONS

This application is a continuation-in-part of U.S. patent application Ser. No. 10/897,715 filed on Jul. 23, 2004. This application also claims priority from U.S. Provisional Patent Application Ser. No. 60/640899 filed on Dec. 30, 2004.

### BACKGROUND OF THE INVENTION

1. Field of the Invention

This invention relates generally to borehole formation evaluation instrumentation and methods of using such instrumentation in the drilling of directional wells. More particularly, this invention relates to a method for measuring the position of a drillstring while drilling a horizontal borehole and maintaining the drillstring within desired boundaries using electromagnetic propagation based earth formation evaluation tools.

2. Description of the Related Art

To obtain hydrocarbons such as oil and gas, well boreholes are drilled by rotating a drill bit attached at a drill string end. The drill string may be a jointed rotatable pipe or a coiled tube. Boreholes may be drilled vertically, but directional drilling systems are often used for drilling boreholes deviated from vertical and/or horizontal boreholes to increase the hydrocarbon production. Modem directional drilling systems generally employ a drill string having a bottomhole assembly (BHA) and a drill bit at an end thereof that is rotated by a drill motor (mud motor) and/or the drill string. A number of downhole devices placed in close proximity to the drill bit measure certain downhole operating parameters associated with the drill string. Such devices typically include sensors for measuring downhole temperature and pressure, tool azimuth, tool inclination. Also used are measuring devices such as a resistivity-measuring device to determine the presence of hydrocarbons and water. Additional downhole instruments, known as measurement-while-drilling (MWD) or logging-while-drilling (LWD) tools, are frequently attached to the drill string to determine formation geology and formation fluid conditions during the drilling operations.

Boreholes are usually drilled along predetermined paths and proceed through various formations. A drilling operator typically controls the surface-controlled drilling parameters during drilling operations. These parameters include weight on bit, drilling fluid flow through the drill pipe, drill string rotational speed (r.p.m. of the surface motor coupled to the drill pipe) and the density and viscosity of the drilling fluid. The downhole operating conditions continually change and the operator must react to such changes and adjust the surface-controlled parameters to properly control the drilling operations. For drilling a borehole in a virgin region, the operator typically relies on seismic survey plots, which provide a macro picture of the subsurface formations and a pre-planned borehole path. For drilling multiple boreholes in the same formation, the operator may also have information about the previously drilled boreholes in the same formation.

In order to maximize the amount of recovered oil from such a borehole, the boreholes are commonly drilled in a substantially horizontal orientation in close proximity to the oil water contact, but still within the oil zone. US Patent RE35386 to Wu et al, having the same assignee as the present application and the contents of which are fully incorporated herein by reference, teaches a method for detecting and sensing boundaries in a formation during directional drilling so that the drilling operation can be adjusted to maintain the drillstring within a selected stratum is presented. The method comprises the initial drilling of an offset well from which resistivity of the formation with depth is determined. This resistivity information is then modeled to provide a modeled log indicative of the response of a resistivity tool within a selected stratum in a substantially horizontal direction. A directional (e.g., horizontal) well is thereafter drilled wherein resistivity is logged in real time and compared to that of the modeled horizontal resistivity to determine the location of the drill string and thereby the borehole in the substantially horizontal stratum. From this, the direction of drilling can be corrected or adjusted so that the borehole is maintained within the desired stratum. The configuration used in the Wu patent is schematically denoted in FIG. 1 by a borehole 15 having a drilling assembly 21 with a drill bit 17 for drilling the borehole. The resistivity sensor is denoted by 19 and typically comprises a transmitter and a plurality of sensors. Measurements may be made with propagation sensors that operate in the 400 kHz and higher frequency, typically 2 Mhz.

A limitation of the method and apparatus used by Wu is that resistivity sensors are responsive to oil/water contacts for relatively small distances, typically no more than 5 m; at larger distances, conventional propagation tools are not responsive to the resistivity contrast between water and oil. Wu discloses the use of a device in which a single transmitter is used and amplitude and phase measurements are made at two spaced apart receivers. U.S. Pat. No. 5,869,968 to Brooks et al. having the same assignee as the present invention discloses a dual propagation resistivity (DPR) tool in which a pair of transmitters are symmetrically disposed about a pair of receivers. With the arrangement in Brooks, it is possible to avoid the effect of mutually coupling between receivers in a propagation resistivity tool. However, even with the DPR device, it is difficult to get the necessary accuracy to see boundaries that are tens of meters from the borehole. It should be noted for the purposes of the present invention, the term boundaries includes boundaries between geologic formations as well as boundaries between different fluids in the subsurface.

An indication of the desired precision of measurements can be seen in FIGS. 2 and 3. Shown are simulations of amplitude (FIG. 2) and phase (FIG. 3) for a 3D model in which resistivity of the water-wet formation was taken as 0.2 Ωm, the resistivity of the oil-wet formation was 20 Ωm. The abscissa is the distance to the oil-water interface. Shown in FIG. 2 are amplitude ratios (in dB) for two receivers. The amplitude ratios have been normalized to amplitude ratios at a distance of 20 m, i.e., they are not absolute amplitude ratios. Similarly, FIG. 3 shows relative phase differences between measurements at the two receivers normalized to the phase difference at 20 m. The spacing between the two receivers for the model was 5 m. The spacing between the transmitter and the near receiver was 12 m.

In FIG. 2, curves 31, 32, 33, 34, 35 and 36 are the normalized amplitude ratios for frequencies of 4 kHz, 20 kHz, 60 kHz, 100 kHz, 200 kHz and 400 kHz respectively. In FIG. 3, curves 41, 42, 43, 44, 45 and 46 are the normalized phase differences for frequencies of 4 kHz, 20 kHz, 60 kHz, 100 kHz, 200 kHz and 400 kHz respectively. An important point to note is that at 400 kHz, both the amplitude ratios and the phase differences are relatively unresponsive at distances of less than 10 m. This is consistent with results shown in Wu.

The simulation results also show that even at lower frequencies, a high level of precision is required in the amplitude and phase measurements in order to use them as distance indicators. Such a precision has hitherto not been possible at lower frequency tools (less than about 400 kHz).

It would be desirable to have an apparatus and a method of using the apparatus that is able to identify bed boundaries at distances greater than 10 m for the purposes of reservoir navigation. Such an apparatus should have a high level of precision and be relatively simple to use. The present invention satisfies this need.

### SUMMARY OF THE INVENTION

One embodiment of the invention is an apparatus for evaluating a subsurface earth formation. The apparatus includes a downhole assembly conveyed in a borehole in the earth formation. The downhole assembly includes at least one transmitter which produces an electromagnetic field in the earth formation, and at least one receiver which produces a signal in response to the electromagnetic field. The apparatus also includes a processor which determines from the signal a distance to a boundary in the earth formation when the boundary has a transition zone of resistivity on one side of the boundary. The processor may determine the distance based in part on a resistivity model. An inversion may be performed to determine the distance. The downhole assembly may be a bottomhole assembly conveyed on a drilling tubular. The processor may control the drilling direction of the bottomhole assembly based on the determined distance. The processor which controls the drilling direction may be on the bottomhole assembly. The boundary may be an oil-water contact, a gas-oil contact, a boundary between a reservoir rock and a caprock, or a shale-water boundary. The at least one transmitter and the at least one receiver may include a first transmitter and a first pair of receivers and a second transmitter and a second pair of receivers that form a multiple propagation resistivity sensor arrangement. The first transmitter and first pair of receivers have a greater depth of investigation than the MPR. When the MPR is used, the processor determines the distance based at least in part on an amplitude difference and/or a phase difference between the signals from the two receivers of the MPR.

Another embodiment of the invention is a method of evaluating an earth formation. An electromagnetic field is produced in the earth formation and a signal is produced in response to the electromagnetic field. The distance to a boundary in the earth formation is determined from the signal when the boundary has a transition zone of resistivity on one side. The distance may be determined based at least in part on a resistivity model. The distance may be determined by performing an inversion. The electromagnetic signal may be produced by a transmitter on a bottomhole assembly (BHA) conveyed on a drilling tubular and the signal may be produced by a receiver on the BHA. The direction of drilling of the BHA may be controlled based on the determined distance. The control of the drilling direction may be done by using a processor on the BHA. The boundary may be an oil-water contact, a gas-oil contact, a boundary between a reservoir rock and a caprock and/or a shale-water boundary. The transition zone may have a resistivity profile that is known or unknown.

Another embodiment of the invention is a machine readable medium for use with an apparatus for evaluating a subsurface earth formation. The apparatus includes a downhole assembly conveyed in a borehole in the earth formation. The downhole assembly includes a transmitter which produces an electromagnetic field in the earth formation, and at least one receiver which produces a signal in response to the electromagnetic field. The medium includes instructions that enable a processor to determine from the signal a distance to a boundary in the earth formation, the boundary having a transition zone of resistivity on one side of the boundary. The medium may be a ROM, an EPROM, an EAROM, a Flash Memory, and/or an Optical disk.

### BRIEF DESCRIPTION OF THE DRAWINGS

The present invention is best understood with reference to the accompanying figures in which like numerals refer to like elements, and in which: FIG. 1 is an illustration of a substantially horizontal borehole proximate to an oil/water contact in a reservoir;

FIG. 2 shows simulation results for normalized amplitude ratios at two receivers for different distances from an oil water contact;

FIG. 3 shows simulation results for normalized phase difference at two receivers for different distances from an oil water contact;

FIG. 4 (Prior Art) shows a logging-while-drilling tool suitable for use with the present invention;

FIG. 5 shows the transmitter-receiver configuration;

FIG. 6 is a view of the resistivity sub of the present invention;

FIG. 7 is a block diagram showing the various components of the resistivity sensor system and associated transfer functions;

FIGS. 8a-c illustrate an example of the interleaving of the primary resistivity measurements with calibration measurements and secondary measurements;

FIG. 9 shows use of the apparatus in a deviated borehole for reservoir navigation;

FIG. 10 illustrates the resistivity and saturation profiles in Grane field of North Sea clearly show the existence of a J-shape resistivity transition zone;

FIG. 11 shows a comparison of inverted distances with the true value from inverting different noisy data with two different noise levels for the model shown in the first track: the resistivity profile is assumed to be true; and

FIG. 12 shows the effect on the inverted distances of assuming an incorrect resistivity profile.

### DETAILED DESCRIPTION OF THE INVENTION

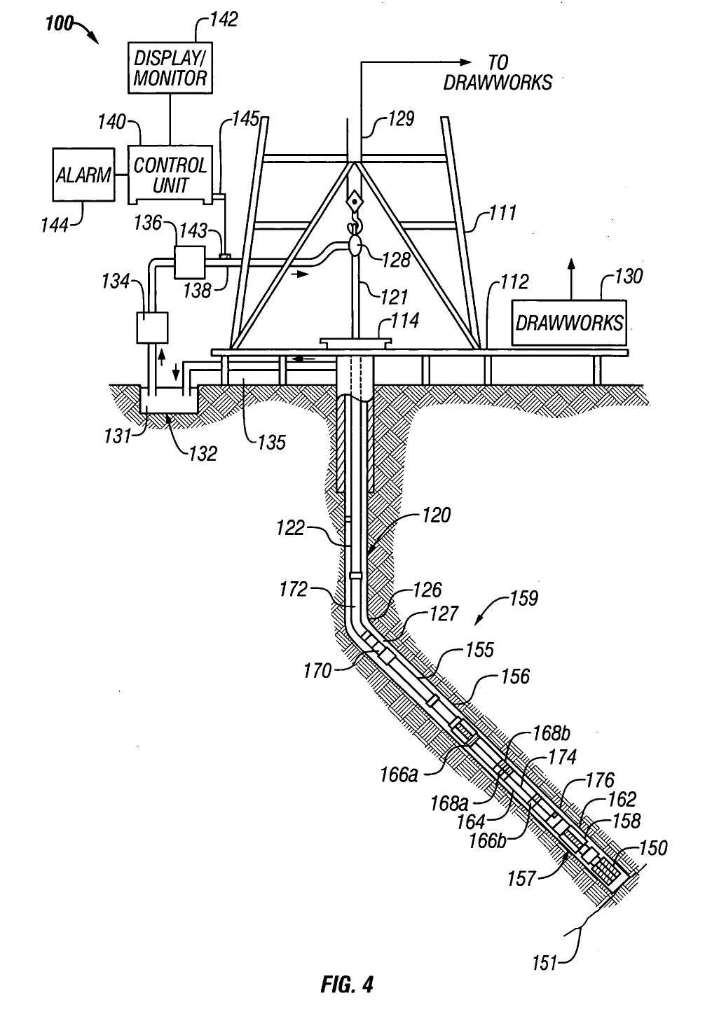

FIG. 4 shows a schematic diagram of a drilling system 110 having a downhole assembly containing an acoustic sensor system and the surface devices according to one embodiment of present invention. As shown, the system 110 includes a conventional derrick 111 erected on a derrick floor 112 which supports a rotary table 114 that is rotated by a prime mover (not shown) at a desired rotational speed. A drill string 120 that includes a drill pipe section 122 extends downward from the rotary table 114 into a borehole 126. A drill bit 150 attached to the drill string downhole end disintegrates the geological formations when it is rotated. The drill string 120 is coupled to a drawworks 130 via a kelly joint 121, swivel 118 and line 129 through a system of pulleys 127. During the drilling operations, the drawworks 130 is operated to control the weight on bit and the rate of penetration of the drill string 120 into the borehole 126. The operation of the drawworks is well known in the art and is thus not described in detail herein.

During drilling operations a suitable drilling fluid (commonly referred to in the art as “mud”) 131 from a mud pit 132 is circulated under pressure through the drill string 120 by a mud pump 134. The drilling fluid 131 passes from the mud pump 134 into the drill string 120 via a desurger 136, fluid line 138 and the kelly joint 121. The drilling fluid is discharged at the borehole bottom 151 through an opening in the drill bit 150. The drilling fluid circulates uphole through the annular space 127 between the drill string 120 and the borehole 126 and is discharged into the mud pit 132 via a return line 135. Preferably, a variety of sensors (not shown) are appropriately deployed on the surface according to known methods in the art to provide information about various drilling-related parameters, such as fluid flow rate, weight on bit, hook load, etc.

A surface control unit 140 receives signals from the downhole sensors and devices via a sensor 143 placed in the fluid line 138 and processes such signals according to programmed instructions provided to the surface control unit. The surface control unit displays desired drilling parameters and other information on a display/monitor 142 which information is utilized by an operator to control the drilling operations. The surface control unit 140 contains a computer, memory for storing data, data recorder and other peripherals. The surface control unit 140 also includes models and processes data according to programmed instructions and responds to user commands entered through a suitable means, such as a keyboard. The control unit 140 is preferably adapted to activate alarms 144 when certain unsafe or undesirable operating conditions occur.

A drill motor or mud motor 155 coupled to the drill bit 150 via a drive shaft (not shown) disposed in a bearing assembly 157 rotates the drill bit 150 when the drilling fluid 131 is passed through the mud motor 155 under pressure. The bearing assembly 157 supports the radial and axial forces of the drill bit, the downthrust of the drill motor and the reactive upward loading from the applied weight on bit. A stabilizer 158 coupled to the bearing assembly 157 acts as a centralizer for the lowermost portion of the mud motor assembly. The use of a motor is for illustrative purposes and is not a limitation to the scope of the invention.

In one embodiment of the system of present invention, the downhole subassembly 159 (also referred to as the bottomhole assembly or “BHA”) which contains the various sensors and MWD devices to provide information about the formation and downhole drilling parameters and the mud motor, is coupled between the drill bit 150 and the drill pipe 122. The downhole assembly 159 preferably is modular in construction, in that the various devices are interconnected sections so that the individual sections may be replaced when desired.

Still referring to FIG. 4, the BHA also preferably contains sensors and devices in addition to the above-described sensors. Such devices include a device for measuring the formation resistivity near and/or in front of the drill bit, a gamma ray device for measuring the formation gamma ray intensity and devices for determining the inclination and azimuth of the drill string. The formation resistivity measuring device 164 is preferably coupled above the lower kick-off subassembly 162 that provides signals, from which resistivity of the formation near the drill bit 150 is determined. A multiple propagation resistivity device (“MPR”) having one or more pairs of transmitting antennae 166a and 166b spaced from one or more pairs of receiving antennae 168a and 168b is used. Magnetic dipoles are employed which operate in the medium frequency and lower high frequency spectrum. In operation, the transmitted electromagnetic waves are perturbed as they propagate through the formation surrounding the resistivity device 164. The receiving antennae 168a and 168b detect the perturbed waves. Formation resistivity is derived from the phase and amplitude of the detected signals. The detected signals are processed by a downhole circuit or processor that is preferably placed in a housing 170 above the mud motor 155 and transmitted to the surface control unit 140 using a suitable telemetry system 172. In addition to or instead of the propagation resistivity device, a suitable induction logging device may be used to measure formation resistivity.

The inclinometer 174 and gamma ray device 176 are suitably placed along the resistivity measuring device 164 for respectively determining the inclination of the portion of the drill string near the drill bit 150 and the formation gamma ray intensity. Any suitable inclinometer and gamma ray device, however, may be utilized for the purposes of this invention. In addition, an azimuth device (not shown), such as a magnetometer or a gyroscopic device, may be utilized to determine the drill string azimuth. Such devices are known in the art and are, thus, not described in detail herein. In the above-described configuration, the mud motor 155 transfers power to the drill bit 150 via one or more hollow shafts that run through the resistivity measuring device 164. The hollow shaft enables the drilling fluid to pass from the mud motor 155 to the drill bit 150. In an alternate embodiment of the drill string 120, the mud motor 155 may be coupled below resistivity measuring device 164 or at any other suitable place.

The drill string contains a modular sensor assembly, a motor assembly and kick-off subs. In one embodiment, the sensor assembly includes a resistivity device, gamma ray device and inclinometer, all of which are in a common housing between the drill bit and the mud motor. The downhole assembly of the present invention preferably includes a MWD section 168 which contains a nuclear formation porosity measuring device, a nuclear density device, an acoustic sensor system placed, and a formation testing system above the mud motor 164 in the housing 178 for providing information useful for evaluating and testing subsurface formations along borehole 126. A downhole processor may be used for processing the data.

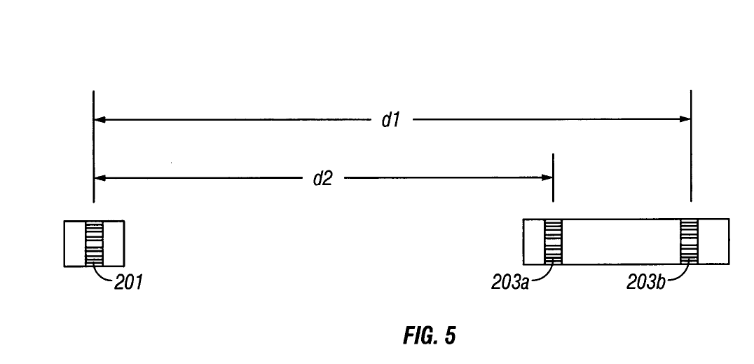

The arrangement of the transmitter 201 and the receivers 203a, 203b is as indicated in FIG. 5. The transmitter is at a distance d1 from the far receiver and a distance d2 from the near receiver. In one embodiment of the invention, the distances d1 and d2 are 17 m and 12 m respectively. One of the novel features of the present invention is the calibration of the receivers to provide the necessary precision of resistivity measurements. This is discussed next.

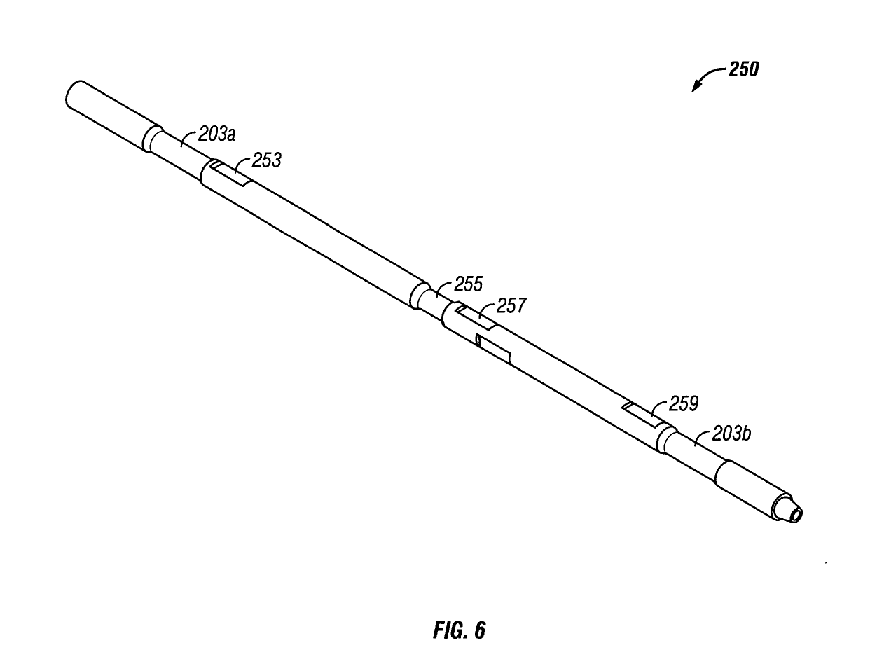

Turning now to FIG. 6, the receiver sub is generally indicated by 250. Included in the receiver sub is a first receiver antenna, designated by 203a, and the corresponding receiver electronics, denoted by 253. The second receiver antenna and the corresponding receiver electronics are denoted by 203b and 259 respectively. An additional calibration antenna 257 may be provided, along with electronics in the center section 255.

In one embodiment of the invention, magnetic fields are generated in the transmitter 201 at 2 measurement frequencies. The two frequencies may be 20 kHz and 50 kHz respectively. As a result of the transmitter excitation, eddy currents are generated in the formation. These eddy currents in turn induce electrical voltages and currents in the receiver coils. The magnitude and phase relationships between the receiver voltages at the individual frequencies are dependent on a number of parameters. These include (i) the distance to the oil-water contact (OWC distance), (ii) the mud resistivity, (iii) the resistivity of the oil bearing formation, (iv) the resistivity of the water bearing formation, (v) the borehole diameter, and, (vi) the transmitter-receiver spacing. If the last five parameters are kept relatively constant or are known, the primary source of change—albeit very small—will be the OWC distance, which is the quantity used in reservoir navigation.

It is well known that the transmitter and receiver electronics can be quite sensitive to temperature variations, particularly in the borehole environment. There may be slight variations in the temperature sensitivity of the two receivers, the variations being sufficient to dominate the changes in receiver signals caused by changes in the distance to the oil-water contact. For this reason, it is important to have proper calibration of the receivers. Two approaches may be used in the present invention to achieve this calibration.

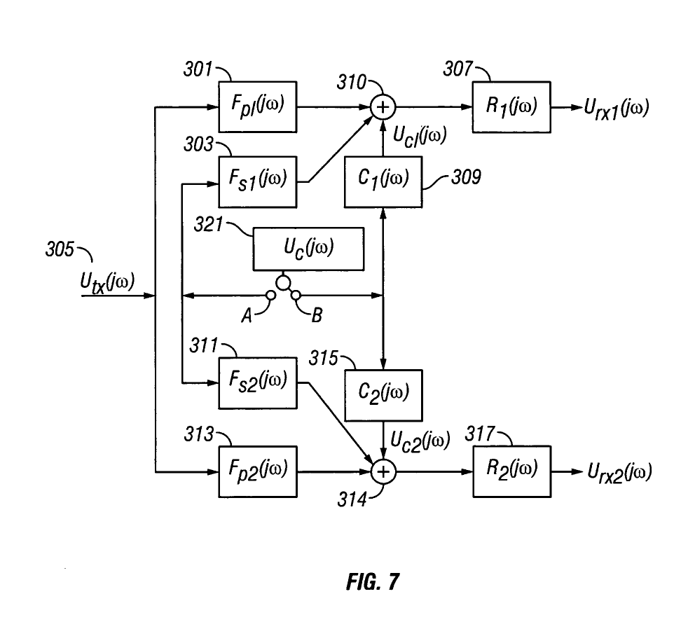

The process is schematically illustrated in FIG. 7. 305 where the spectrum Uₜₓ(jω) denotes the transmitter output in the frequency domain c. The transfer function Fₚ₁(ω) 301 is used to characterize the signal transfer from the transmitter antenna to the first receiver antenna while transfer function Fₚ₂(ω) 313 is used to characterize the signal transfer from the transmitter antenna to the second receiver antenna. Both transfer functions Fₚ₁(ω) and Fₚ₂(ω) are functions of the electrical formations properties (conductivity and permittivity) and the impedances of the respective transmitter and receiver antennas. We further denote by R₁(jω) 307 and R₂(jω) 317 the transfer functions of the two receivers. Then the outputs of the two receivers Uᵣₓ₁(jω) and Uᵣₓ₁(jω), which may be called the primary measurements, in response to a transmitter excitation Uₜₓ(jω) are given by:
Uᵣₓ₁(jω)=Fₚ₁(jω)×R₁(jω)×Uₜₓ(jω) (1)
and
Uᵣₓ₂(jω)=Fₚ₂(jω)×R₂(jω)×Uₜₓ(jω) (2)
respectively.

The ratio of the two receiver outputs is

$${A}_{mp} ( jω ) = \frac{{U}_{rx2} ( jω )}{{U}_{rx1} ( jω )} = \frac{{F}_{p2} ( jω ) \times {R}_{2} ( jω )}{{F}_{{p}_{1}} ( jω ) \times {R}_{1} ( jω )} . \qquad ( 3 )$$

For the case in which the two receiver transfer functions are identical, i.e., for
R₁(jω)=R₂(jω) (4)
eqn. (3), gives the desired differential formation property between the two receivers, i.e.,

$${A}_{mp} ( jω ) = {A}_{fp} ( jω ) = \frac{{F}_{p2} ( jω )}{{F}_{p1} ( jω )} . \qquad ( 5 )$$

In reality, eqn. (4) is not necessarily satisfied, and, in most situations, the difference between the two receiver transfer functions is sufficiently large that the differential formation property between the two receivers is not given by eqn. (3). The relative calibration is determined in the present invention by use of calibration circuits 309 and 315 having known calibration transfer functions C₁(jω) and C₂(jω) respectively. The circuits represented by C₁(jω) and C₂(jω) may be resistive attenuators connected by coaxial cables between the calibration source and the corresponding receiver input. In one embodiment of the invention, transformers (depicted by 310, 314) may be used for coupling the coaxial cables to the corresponding receiver. In an alternate embodiment of the invention, the coaxial cable may be connected to a secondary winding on the core (not shown) of the receiver antenna.

Specifically, a signal from a calibration source 321 having a spectrum U_{c}(jω) is sent to calibration circuits 309 and 315, i.e., with the source connected to switching position B. The respective receiver outputs in response to the calibration signal are given by
Uᵣₓ₁(jω)=C₁(jω)×R₁(jω)×U_{c}(jω) (6)
and
Uᵣₓ₂(jω)=C₂(jω)×R₂(jω)×U_{c}(jω) (7)
respectively.

The calibration measurement transfer function is defined as the ratio A_{c}(jω) of the receiver outputs in response to the calibration signal

$${A}_{c} ( jω ) = \frac{{U}_{rx2} ( jω )}{{U}_{rx1} ( jω )} = \frac{{C}_{2} ( jω ) \times {R}_{2} ( jω )}{{C}_{1} ( jω ) \times {R}_{1} ( jω )} \qquad ( 8 )$$

which gives the desired receiver calibration as

$$\frac{{R}_{1} ( jω )}{{R}_{2} ( jω )} = \frac{{C}_{2} ( jω )}{{C}_{1} ( jω )} \times \frac{1}{{A}_{c} ( jω )} . \qquad ( 9 )$$

Since

$${A}_{fp} ( jω ) = {A}_{mp} ( jω ) \times \frac{{R}_{1} ( jω )}{{R}_{2} ( jω )} ,$$

this gives the result

$${A}_{fp} ( jω ) = \frac{{A}_{mp} ( jω )}{{A}_{c} ( jω )} \times \frac{{C}_{2} ( jω )}{{C}_{1} ( jω )} . \qquad ( 10 )$$

This may be simplified as

$$\begin{matrix}{A}_{fp} ( jω ) = \frac{{A}_{mp} ( jω ) \times {C}_{c} ( jω )}{{A}_{c} ( jω )} \\ where & ( 11 ) \\ {C}_{c} ( jω ) = \frac{{U}_{c2} ( jω )}{{U}_{c1} ( jω )} = \frac{{C}_{2} ( jω )}{{C}_{1} ( jω )} & ( 12 )\end{matrix}$$

is a combined calibration transfer function. Thus, if the combined calibration transfer function is known, then the desired formation property is determined from the measured receiver signals and the combined calibration transfer function.

In operation, two separate calibration networks are used and, if necessary, the combined calibration transfer function C_{c}(jω) is determined over a range of temperatures. The calibration transfer function may then be stored in a table in downhole memory along with the corresponding temperature. A downhole temperature sensor measures the operating temperature of the receiver sub and the stored calibration transfer function corresponding to the measured temperature may be used for processing the receiver signals. In the present invention, these processed resistivities are used for reservoir navigation as discussed below.

In an alternate embodiment of the invention, the measured amplitude ratios, phase differences and temperature are telemetered to the surface where the correct resistivity is determined. The reservoir navigation may then be done using a surface processor with human involvement.

In operation, the calibration circuit may be switched to connect to an additional antenna referred to as a calibration antenna 255. Under these conditions,

$${A}_{fs} ( jω ) = \frac{{A}_{ms} ( jω ) \times {C}_{c} ( jω )}{{A}_{c} ( jω )} . \qquad ( 13 )$$

Since the calibration antenna is positioned between the two receiver antennas, A_{fs}(jω) should not be responsive to the distance to the OWC. Any changes in A_{fs}(jω) are thus indicative of possible changes in something other than the distance to the OWC. These other factors could include changes in borehole diameter and changes in earth resistivity. The measurements made by the calibration antenna thus serve as quality control for the primary measurements.

To reduce the acquisition time and/or to maintain spatial resolution of the measurements, it is desirable to make the primary measurements, the calibration measurements and the secondary measurements simultaneously. For this reason, the calibration measurements are made at a frequency slightly different from each of the frequencies for the primary measurements. For example, if the primary frequency is denoted by f (corresponding to an angular frequency ω=2πf), then the following constraints are imposed:

$$\vert \frac{{C}_{c} ( jω )}{{C}_{c} ( j ( ω + δ ω ) )} \vert < 0.01 dB \\ \vert Ang \{ {C}_{c} ( jω ) - {C}_{c} ( j ( ω + δ ω ) ) \} \vert < 0.01 ° . \qquad ( 14 )$$

The limits of 0.01 dB and 0.010 are selected on the basis of the required accuracy for determination of the distance to the OWC. An additional consideration is that the clocks controlling the oscillators are frequencies f and f+δf be stable. In order to meet the stability requirements, a downhole atomic clock such as that described in U.S. patent application Ser. No. 10/664,664 of DiFoggio et al. filed on Sep. 18, 2003 and the contents of which are incorporated herein by reference, may be used.

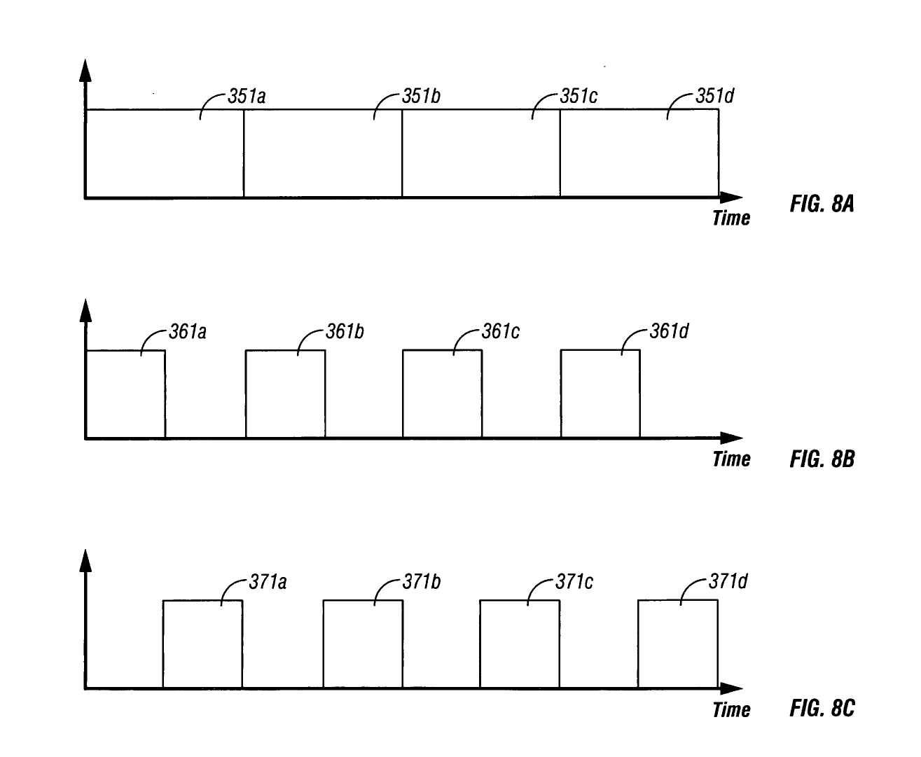

In order to meet the requirements for simultaneous acquisition of the primary, secondary and calibration measurements, the primary measurements are made substantially continuously while the secondary and calibration measurements have suitable time slots allocated. This is schematically illustrated in FIG. 8a where the resistivity measurements are denoted by 351a, 351b, 351c, 351d, 351e while the calibration measurements (FIG. 8b) denoted by 361a, 361b, 361c, 361d are interleaved with the secondary measurements 371a, 371b, 371c, 371d (FIG. 8d).

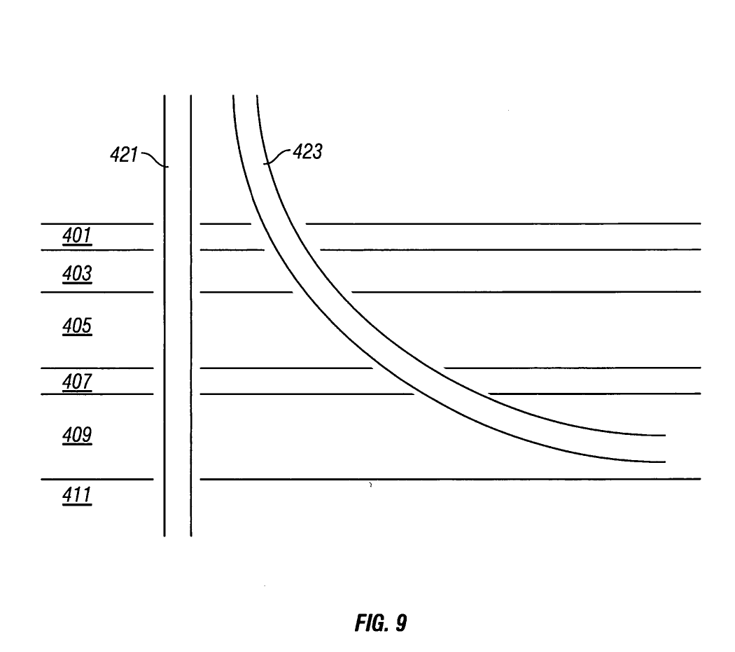

As discussed in Wu, an initial resistivity model is obtained for the geologic interval of interest. This may be done by logging a vertical or near vertical well in the vicinity of where the horizontal well is to be drilled. This is illustrated in FIG. 9 where layers 401, 403, 405, 407, 409, and 411 are shown. 409 may be oil saturated reservoir rock while 411 may be water saturated. An initial well 421 is shown and resistivity measurements made in the initial well are used for modeling and reservoir navigation of the later well 423. The objective is to maintain the horizontal well at a specified distance from the OWC within 409. An additional objective may be to maintain the horizontal well within the layer 409 and avoid the caprock 407. Using the apparatus described above, resistivity values (amplitude ratios and phase differences) can be monitored while drilling and, based on model values, a distance to a boundary can be determined.

In a significant number of reservoirs, due to hydrodynamic effects, the OWC may not be horizontal. In such a case, the continuous monitoring of the distance is necessary and simply maintaining the borehole at a fixed depth (determinable from gyro measurements) will not be adequate.

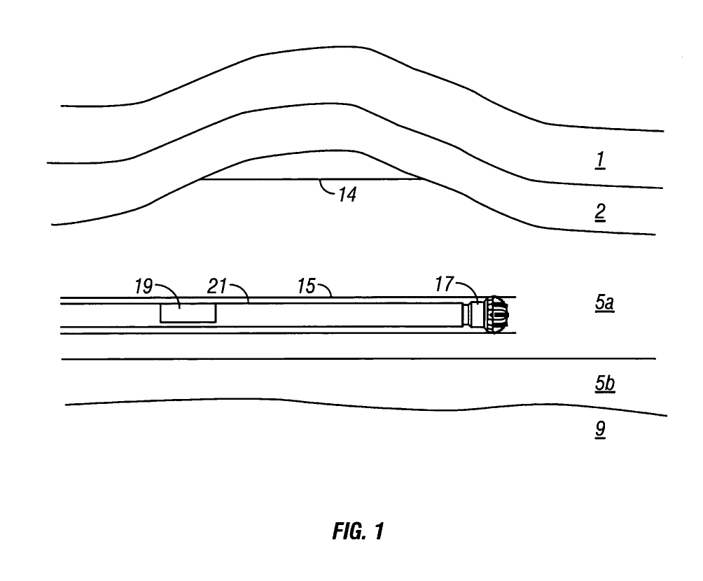

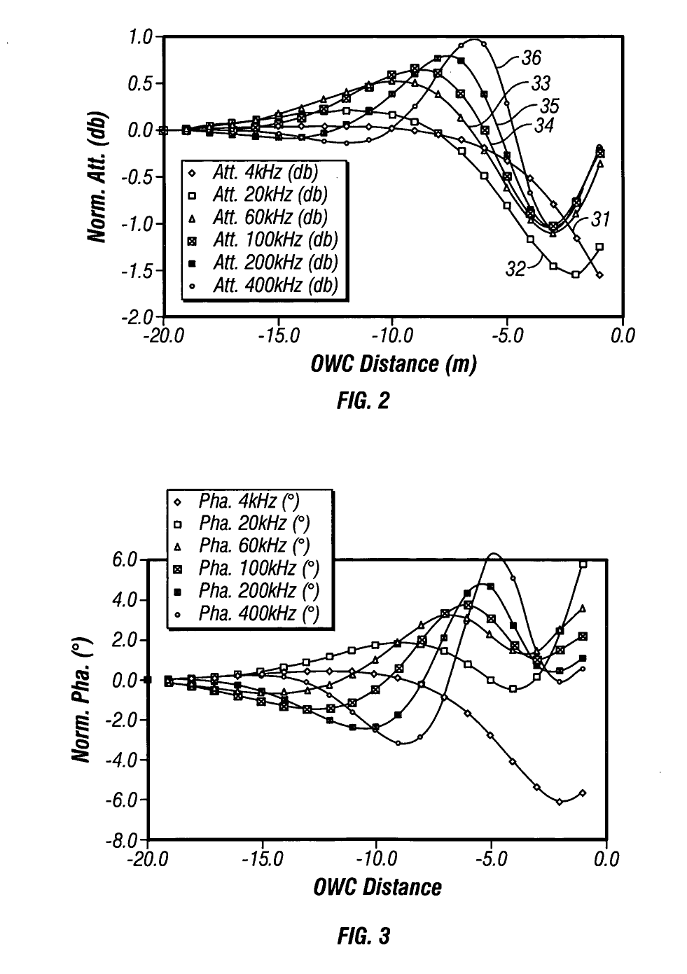

In practice, it has been found that the calibration circuits C₁(jω) and C₂(jω) (and in particular, their ratio) may have little temperature variation. While it is necessary to know the absolute value of their ratio for determination of resistivity, such is not the case for reservoir navigation where stability of the ratio is sufficient. We note that FIGS. 2-3 show relative changes in resistivity as a function of distance from the OWC. Precision of the measurements (i.e., repeatability) within the limits noted in eqn. (14) is sufficient and the absolute accuracy of the resistivity measurements is not critical. In one embodiment of the invention, the ratio is established once and an assumption of stability is made. Under this assumption, temperature monitoring and correction is not required.

To further confirm the feasibility of the new deep-reading LWD resistivity tool, we studied the feasibility of using the new resistivity tool to quantitatively determine the distance to a remote bed. An inversion technique is employed to process the synthetic responses. To make our studies more practical, we assumed that the resistive bed (hydrocarbon reservoir) possesses a transition zone within which the resistivity drops gradually toward the conductive layer. A similar approach can be found in the paper by Seydoux et. al. Since a resistivity profile of a transition zone may be different from well to well, we describe the resistivity profile as a J-shape function and include it in our inversion. By doing so, the inaccuracy of the determined distance due to the uncertainty of resistivity profiles is reduced. We found with reasonably accurate measurements, the tool can locate the remote bed boundary even in the presence of a resistivity transition zone with certain uncertainties.

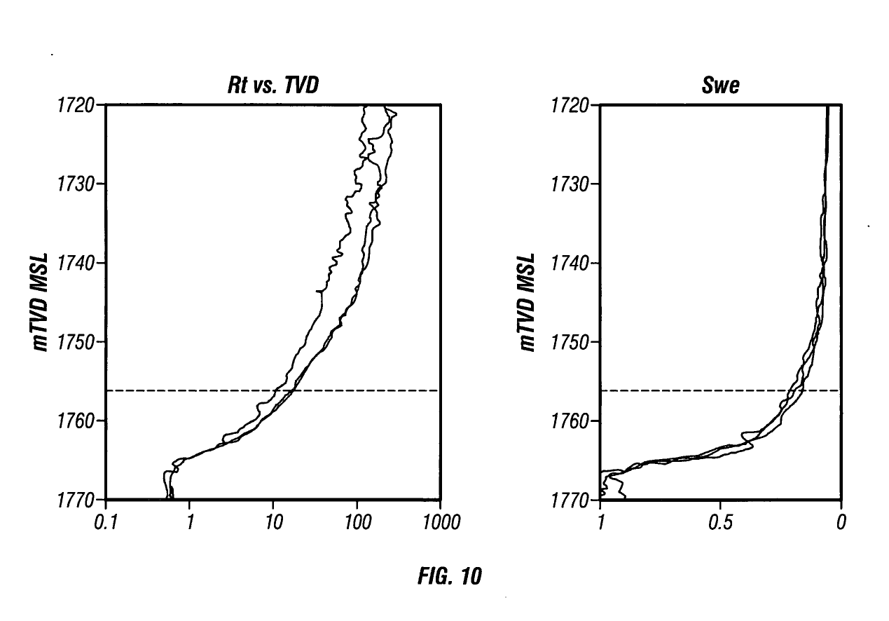

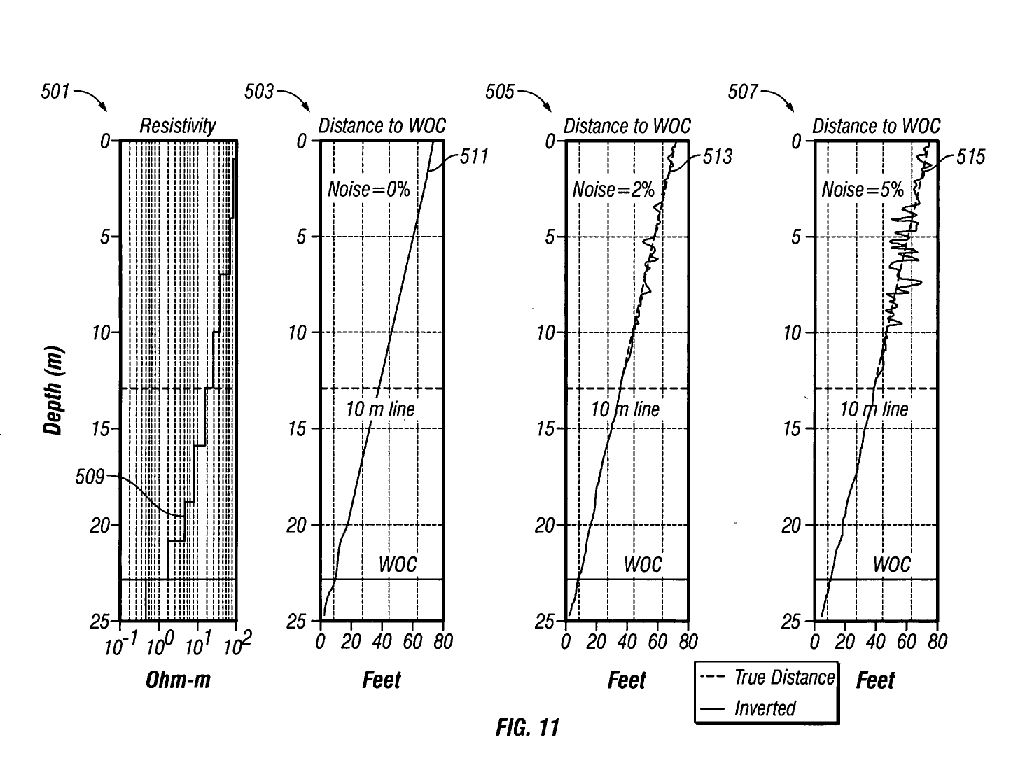

In geosteering, it is important to maintain the drill bit inside a target layer (pay zone). Usually, below the pay zone is a water zone. The distance from the tool to a water-oil contact (WOC) is needed to avoid producing water. Using MPR and the resistivity profile from offset well, the tool can be steered to be within a certain target layer. However, in some fields, as in Grane field of North Sea, the resistivity profile indicates the existence of a transition zone, within which the resistivity gradually decreases toward the conductive water layer (FIG. 10). As a further complication, the resistivity profile behaves different from well to well. This increases the difficulty of determining the distance of the tool to the WOC. By assuming the resistivity profile, we employed an inversion scheme to determine the distance. The distance can be accurately inverted when the resistivity profile is assumed to be right. FIG. 11 shows the inversion results for the data of different noise levels. Track 1 501 shows the resistivity profile 509. Track 2 503 shows a curve 511 showing the estimated distance to the WOC at different depths of measurement using the known resistivity profile and no measurement noise. Track 3 505 shows the estimated distance 513 to the WOC for 2% additive noise. Track 4 507 shows the estimated distance 515 to the WOC for 5% additive noise. The noise causes some uncertainties but is minimal. For each depth level, the tool is horizontally deployed. We next address the sensitivity of the inversion to uncertainties in the resistivity profile.

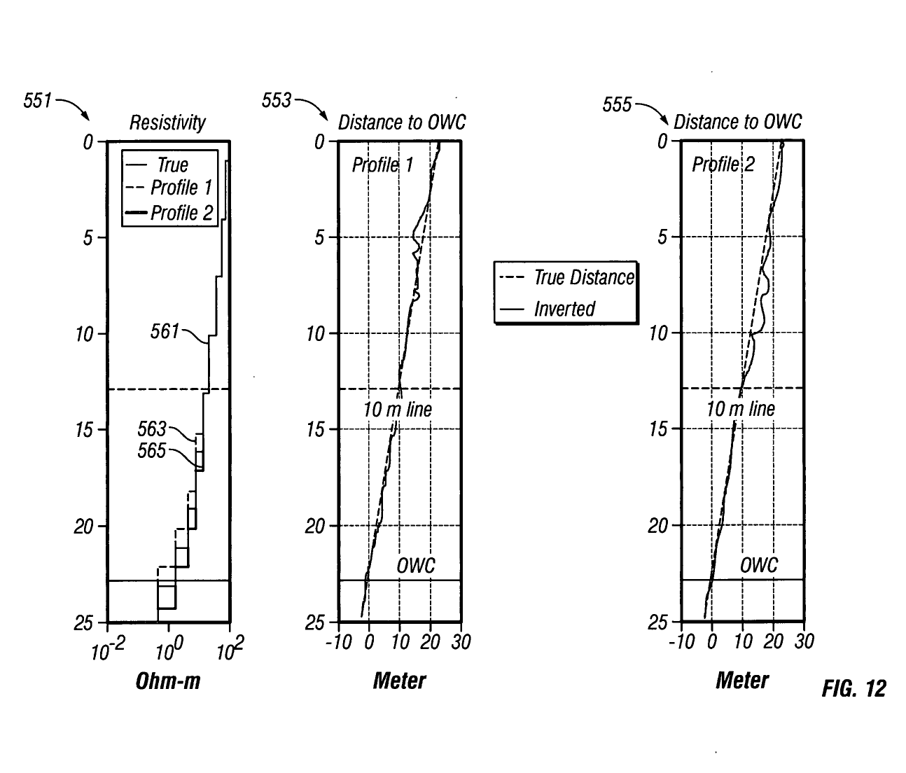

The uncertainties in a transition zone resistivity profile will definitely cause some uncertainties in the inverted distance to the WOC as shown in FIG. 12. Track 1 551 shows the true resistivity profile 561. Track 2 553 shows two curves of estimated distance to the WOC: one is derived assuming the true resistivity profile and the second one is estimated using the incorrect resistivity profile 563. Similarly, track 3 555 shows two curves of estimated distance to the WOC: one is derived assuming the true resistivity profile and the other is derived using the incorrect resistivity profile 565. The results show that the discrepancies are small when the modeled resistivity profile is different from the true resistivity when distances are less than 10 m. Larger discrepancies occur when distance is greater than 10 m. The results suggest that even if the transition zone resistivity profile is not precisely known, a tolerable estimate (within the range of 1 m) can be obtained for distance to the remote bed boundary.

The operation of the transmitters and receivers, and the control of the drilling direction may be controlled by the downhole processor and/or a surface processor. Implicit in the control and processing of the data is the use of a computer program on a suitable machine readable medium that enables the processor to perform the control and processing. The machine readable medium may include ROMs, EPROMs, EAROMs, Flash Memories and Optical disks. The term “processor” as used herein is intended to include Field Programmable Gate Arrays (FPGAs).

While the foregoing disclosure is directed to the preferred embodiments of the invention, various modifications will be apparent to those skilled in the art. It is intended that all such variations within the scope of the appended claims be embraced by the foregoing disclosure.

What is claimed is:

1. An apparatus for evaluating a subsurface earth formation, the apparatus comprising:
(a) a downhole assembly conveyed in a borehole in the earth formation, said downhole assembly including:
(A) at least one transmitter which produces an electromagnetic field in the earth formation, and
(B) at least one receiver which produces a signal in response to the electromagnetic field; and
(b) a processor which determines from the signal a distance to a boundary in said earth formation, the boundary having a transition zone of resistivity on one side of the boundary.

2. The apparatus of claim 1 wherein said processor determines the distance based in part on a resistivity model.

3. The apparatus of claim 1 wherein the processor determines the distance by performing an inversion.

4. The apparatus of claim 1 wherein the downhole assembly further comprises a bottomhole assembly conveyed on a drilling tubular.

5. The apparatus of claim 4 further comprising a processor which controls a direction of drilling of the BHA based on the determined distance.

6. The apparatus of claim 5 wherein the processor which controls the drilling is on the BHA.

7. The apparatus of claim 1 wherein said boundary is one of (i) an oil-water contact, (ii) a gas-oil contact, and, (iii) a boundary between a reservoir rock and a caprock and (iv) a shale-water boundary.

8. The apparatus of claim 1 wherein the transition zone comprises a resistivity with a variation in resistivity.

9. The apparatus of claim 1 wherein the at least one transmitter and the at least one receiver further comprise:
(i) a first transmitter and a first pair of receivers, and
(ii) second transmitter and a second pair of receivers defining a multiple propagation resistivity (MPR) sensor arrangement;
wherein the first transmitter and the first pair of receivers have a greater depth of investigation than the MPR sensor arrangement.

10. The apparatus of claim 9 wherein the processor determines the distance based at least in part on at least one of (A) an amplitude difference between signals from the receivers of the MPR sensor arrangement, and (B) a phase difference between signals from the receivers of the MPR sensor arrangement.

11. A method of evaluating an earth formation, the method comprising:
(a) producing an electromagnetic field in the earth formation,
(b) producing a signal in response to the electromagnetic field; and
(c) determining from the signal a distance to a boundary in the earth formation, the boundary having a transition zone of resistivity on one side of the boundary.

12. The method of claim 11 wherein determining the distance is based at least in part on using a resistivity model.

13. The method of claim 11 wherein determining the distance further comprises performing an inversion.

14. The method of claim 1 wherein:
(i) the electromagnetic signal is produced by a transmitter on a bottomhole assembly (BHA) conveyed on a drilling tubular; and
(ii) the signal is produced by a receiver on the BHA;
the method further comprising controlling a direction of drilling of the BHA based on the determined distance.

15. The method of claim 14 wherein controlling the direction of drilling further comprises using a processor on the BHA.

16. The method of claim 11 wherein said boundary is one of (i) an oil-water contact, (ii) a gas-oil contact, and, (iii) a boundary between a reservoir rock and a caprock and (iv) a shale-water boundary.

17. The method of claim 11 wherein the transition zone comprises a resistivity with a variation in resistivity.

18. The method of claim 11 wherein the transition zone comprises one of (i) a known resisitivity profile, and (ii) an unknown resistivity profile.

19. The method of claim 11 wherein producing the electromagnetic field and producing a signal in response to the electromagnetic field further comprises
(i) using a first transmitter and a first pair of receivers, and
(ii) using a second transmitter and a second pair of receivers defining a multiple propagation resistivity (MPR) sensor arrangement;
wherein the first transmitter and the first pair of receivers have a greater depth of investigation than the MPR sensor arrangement.

20. A machine readable medium for use with an apparatus for evaluating a subsurface earth formation, the apparatus comprising:
(a) a downhole assembly conveyed in a borehole in the earth formation, said downhole assembly including:
(A) a transmitter which produces an electromagnetic field in the earth formation, and
(B) at least one receiver which produces a signal in response to the electromagnetic field;
the medium comprising instructions that enable a processor to determine from the signal a distance to a boundary in the earth formation, the boundary having a transition zone of resistivity on one side of the boundary.

21. The medium of claim 20 further comprising at least one of (i) a ROM, (ii) an EPROM, (iii) an EAROM, (iv) a Flash Memory, and (v) an Optical disk.
